(19) United States
(12) Patent Application Publication
(10) Pub. No.: US 2024/0127070 A1
(43) Pub. Date: Apr. 18, 2024

(54) TRAINING A MACHINE-LEARNING MODEL FOR CONSTRAINT-COMPLIANCE PREDICTION USING AN ACTION-BASED LOSS FUNCTION

(71) Applicant: Navan, Inc., Palo Alto, CA (US)

(72) Inventors: Jun Gao, San Jose, CA (US); Ishay Shushu Inbar, Neot HaKikar (IL); Andrei Vodeniktov, Sunnyvale, CA (US); Yuval Refua, Sunnyvale, CA (US); Ilan Twig, San Francisco, CA (US); Felix Milman, Los Gatos, CA (US); Christophe Levesque, San Carlos, CA (US)

(21) Appl. No.: 18/487,821

(22) Filed: Oct. 16, 2023

Related U.S. Application Data
(60) Provisional application No. 63/495,238, filed on Apr. 10, 2023.
(60) Provisional application No. 63/382,713, filed on Nov. 7, 2022.
(60) Provisional application No. 63/416,104, filed on Oct. 14, 2022.

(51) Int. Cl. G06N 3/084

(52) U.S. Cl. CPC G06N 3/084; G06Q 10/04

(57) ABSTRACT

An online system trains a constraint prediction machine-learning model using an action-based loss function. The action-based loss function computes a weighted sum of (1) an accuracy of the constraint prediction model in predicting whether a user's interaction complies with a set of constraints and (2) an action score representing a number of actions taken by users to determine whether the user's action complies with the set of constraints. The online system may apply this trained constraint prediction model to future interaction data received from third-party systems to predict whether user interactions with those third-party systems comply with the set of constraints.

### CROSS-REFERENCE TO RELATED APPLICATIONS

This application claims priority to U.S. Provisional Patent Application No. 63/416,104, U.S. Provisional Patent Application No. 63/382,713, and U.S. Provisional Patent Application No. 63/495,238, each which is incorporated by reference.

### BACKGROUND

Network systems are complex digital ecosystems that encompass a myriad of computing devices, such as servers, workstations, Internet of Things (IoT) gadgets, and mobile devices, all of which interact with one another over a network infrastructure. Both wired and wireless networks are employed to facilitate the seamless communication between these varied components. As a consequence of this interconnectivity, each device continuously generates its own data, culminating in a massive volume of data that warrants meticulous analysis.

Network systems also enable users to interact with one another or with specific systems residing within the network. This interaction could involve information sharing, resource allocation, or communication workflows, among other possibilities. Owing to the diverse and sensitive nature of these activities, certain users may be granted authorization to execute specific actions within the network.

To ensure that users are properly authorized to undertake these actions, network systems may deploy a variety of authentication and authorization mechanisms. One primary aspect involves implementing authorization constraints to ascertain whether a user's action within the network is authorized. However, assessing the applicability of these constraints can necessitate the review of data generated by a multitude of devices. This can be both time-consuming and prone to human error, particularly given the vast volume of generated data.

To address these challenges, some network systems incorporate machine learning models to minimize the need for human intervention in the review of data from disparate devices. Employing advanced computational algorithms, these models strive to identify patterns and correlations that can unveil critical insights into user behaviors and predict potential authorization breaches. To enhance their efficacy, machine learning models are trained for accuracy using labeled training data. This data consists of input-output pairs which contain examples of correct predictions that the model should make based on the embedded features of the input data. By leveraging this training data, the models are fine-tuned to detect and predict security vulnerabilities and potential unauthorized access attempts more accurately.

Nevertheless, these machine learning models often come with intrinsic limitations. They are not explicitly trained to reduce human review of the data, which can lead to the generation of predictions that still necessitate human intervention. Consequently, the models might produce outputs that require further scrutiny to determine whether a given user's action within the network is authorized. Therefore, while network systems serve as indispensable solutions that connect a multitude of computing devices and facilitate collaboration, the sheer volume of data generated presents significant challenges in efficiently managing user authentication and authorization.

### SUMMARY

Described herein is an action-based loss function to use in the training of a constraint prediction machine-learning model. To train the constraint prediction model, an online system initiates a set of parameters for the constraint prediction model and accesses training data comprising multiple training examples. Each training example features interaction data describing a user's interaction with a system within a network, and a label indicating the compliance of said interaction with a set of constraints.

Utilizing the constraint prediction model, the interaction data of each training example is examined to produce a series of constraint predictions. These predictions indicate the likelihood of compliance with the set of constraints for corresponding training examples. The online system accesses action logs from other devices within the network to analyze user actions to determine compliance with the imposed constraints. An action score is computed for each training example based on the action logs, signifying the number of actions undertaken by human users to ascertain compliance with the set of constraints on the subject user.

Employing an action-based loss function, a loss score is calculated for each training example by analyzing the constraint prediction, action score, and label for the respective examples. The parameters for the constraint prediction model are subsequently updated using the computed loss scores in a backpropagation process and a final set of parameters for the constraint prediction model is stored within the computer-readable medium.

In some aspects, the techniques described herein relate to a non-transitory computer-readable medium storing parameters for a constraint prediction model, wherein the parameters for the constraint prediction model are produced by a process including: initializing a set of parameters for the constraint prediction model; accessing training data for the constraint prediction model, wherein the training data includes a plurality of training examples, wherein each training example of the plurality of training examples includes: interaction data describing an interaction of a user with a third-party system; and a label for the training example that indicates whether the interaction of the user with the third-party system complies with a set of constraints; applying the constraint prediction model to the interaction data of each training example of the plurality of training examples to generate a set of constraint predictions for the plurality of training examples, wherein each constraint prediction indicates a predicted likelihood that the interaction of the corresponding training example complies with the set of constraints; accessing action logs from an online system that describe actions taken by users of the online system to determine whether interactions of the plurality of training examples comply with the set of constraints; computing an action score for each training example of the plurality of training examples based on the action logs, wherein each action score represents a number of actions taken by operators of the online system to determine whether the interaction of the corresponding training example complies with the set of constraints; computing a loss score for each of the plurality of training examples by applying an action-based loss function to the constraint prediction, action score, and label for each of the plurality of training examples; updating the set of parameters for the constraint prediction model through a backpropagation process using the computed loss scores for the plurality of training examples; and storing a final set of parameters for the constraint prediction model to the computer-readable medium.

In some aspects, the techniques described herein relate to a computer-readable medium, wherein the constraint prediction model includes a neural network with a plurality of layers, wherein the plurality of layers includes an input layer, a set of intermediate layers, and an output layer, wherein the input layer is connected to the set of intermediate layers, and the set of intermediate layers are connected to the output layer, and wherein applying the constraint prediction model to the interaction data of a training example includes: inputting, to the input layer, a feature vector associated with the interaction data of the training data; receiving a constraint prediction from the output layer.

In some aspects, the techniques described herein relate to a computer-readable medium, wherein computing the action score for a training example of the plurality of training examples includes: identifying a set of actions described in the action logs that are associated with the interaction associated with the interaction data of the training example.

In some aspects, the techniques described herein relate to a computer-readable medium, wherein computing the action score for a training example of the plurality of training examples includes: assigning a score to each action of the identified set of actions; and computing an aggregated score based on the assigned scores.

In some aspects, the techniques described herein relate to a computer-readable medium, wherein applying the action-based loss function to a constraint prediction, action score, and label includes: computing a weighted sum based on the constraint prediction and the action score.

In some aspects, the techniques described herein relate to a computer-readable medium, wherein accessing the action logs includes: receiving action logs from another third-party system, wherein the action logs describe actions of users on that third-party system.

In some aspects, the techniques described herein relate to a method including: receiving interaction data from a third-party system describing an interaction 1; and predicting whether the interaction complies with a set of constraints based on the application of the constraint prediction model to the interaction data.

In some aspects, the techniques described herein relate to a method including: initializing a set of parameters for the constraint prediction model; accessing training data for the constraint prediction model, wherein the training data includes a plurality of training examples, wherein each training example of the plurality of training examples includes: interaction data describing an interaction of a user with a third-party system; and a label for the training example that indicates whether the interaction of the user with the third-party system complies with a set of constraints; applying the constraint prediction model to the interaction data of each training example of the plurality of training examples to generate a set of constraint predictions for the plurality of training examples, wherein each constraint prediction indicates a predicted likelihood that the interaction of the corresponding training example complies with the set of constraints; accessing action logs from an online system that describe actions taken by users of the online system to determine whether interactions of the plurality of training examples comply with the set of constraints; computing an action score for each training example of the plurality of training examples based on the action logs, wherein each action score represents a number of actions taken by operators of the online system to determine whether the interaction of the corresponding training example complies with the set of constraints; computing a loss score for each of the plurality of training examples by applying an action-based loss function to the constraint prediction, action score, and label for each of the plurality of training examples; updating the set of parameters for the constraint prediction model through a backpropagation process using the computed loss scores for the plurality of training examples; and storing a final set of parameters for the constraint prediction model to a non-transitory computer-readable medium.

In some aspects, the techniques described herein relate to a method, wherein the constraint prediction model includes a neural network with a plurality of layers, wherein the plurality of layers includes an input layer, a set of intermediate layers, and an output layer, wherein the input layer is connected to the set of intermediate layers, and the set of intermediate layers are connected to the output layer, and wherein applying the constraint prediction model to the interaction data of a training example includes: inputting, to the input layer, a feature vector associated with the interaction data of the training data; receiving a constraint prediction from the output layer.

In some aspects, the techniques described herein relate to a method, wherein computing the action score for a training example of the plurality of training examples includes: identifying a set of actions described in the action logs that are associated with the interaction associated with the interaction data of the training example.

In some aspects, the techniques described herein relate to a method, wherein computing the action score for a training example of the plurality of training examples includes: assigning a score to each action of the identified set of actions; and computing an aggregated score based on the assigned scores.

In some aspects, the techniques described herein relate to a method, wherein applying the action-based loss function to a constraint prediction, action score, and label includes: computing a weighted sum based on the constraint prediction and the action score.

In some aspects, the techniques described herein relate to a method, wherein accessing the action logs includes: receiving action logs from another third-party system, wherein the action logs describe actions of users on that third-party system.

In some aspects, the techniques described herein relate to a method, further including: receiving interaction data from a third-party system describing an interaction of the user with the third-party system; applying a constraint prediction model to the interaction data by accessing parameters for the constraint prediction model stored by the non-transitory computer-readable medium; and predicting whether the interaction complies with a set of constraints based on the application of the constraint prediction model to the interaction data.

In some aspects, the techniques described herein relate to a non-transitory computer-readable medium storing instructions that, when executed by a processor, cause the processor to perform operations including: initializing a set of parameters for the constraint prediction model; accessing training data for the constraint prediction model, wherein the training data includes a plurality of training examples, wherein each training example of the plurality of training examples includes: interaction data describing an interaction of a user with a third-party system; and a label for the training example that indicates whether the interaction of the user with the third-party system complies with a set of constraints; applying the constraint prediction model to the interaction data of each training example of the plurality of training examples to generate a set of constraint predictions for the plurality of training examples, wherein each constraint prediction indicates a predicted likelihood that the interaction of the corresponding training example complies with the set of constraints; accessing action logs from an online system that describe actions taken by users of the online system to determine whether interactions of the plurality of training examples comply with the set of constraints; computing an action score for each training example of the plurality of training examples based on the action logs, wherein each action score represents a number of actions taken by operators of the online system to determine whether the interaction of the corresponding training example complies with the set of constraints; computing a loss score for each of the plurality of training examples by applying an action-based loss function to the constraint prediction, action score, and label for each of the plurality of training examples; updating the set of parameters for the constraint prediction model through a backpropagation process using the computed loss scores for the plurality of training examples; and storing a final set of parameters for the constraint prediction model to the computer-readable medium.

In some aspects, the techniques described herein relate to a computer-readable medium, wherein the constraint prediction model includes a neural network with a plurality of layers, wherein the plurality of layers includes an input layer, a set of intermediate layers, and an output layer, wherein the input layer is connected to the set of intermediate layers, and the set of intermediate layers are connected to the output layer, and wherein applying the constraint prediction model to the interaction data of a training example includes: inputting, to the input layer, a feature vector associated with the interaction data of the training data; receiving a constraint prediction from the output layer.

In some aspects, the techniques described herein relate to a computer-readable medium, wherein computing the action score for a training example of the plurality of training examples includes: identifying a set of actions described in the action logs that are associated with the interaction associated with the interaction data of the training example.

In some aspects, the techniques described herein relate to a computer-readable medium, wherein computing the action score for a training example of the plurality of training examples includes: assigning a score to each action of the identified set of actions; and computing an aggregated score based on the assigned scores.

In some aspects, the techniques described herein relate to a computer-readable medium, wherein applying the action-based loss function to a constraint prediction, action score, and label includes: computing a weighted sum based on the constraint prediction and the action score.

In some aspects, the techniques described herein relate to a computer-readable medium, wherein accessing the action logs includes: receiving action logs from another third-party system, wherein the action logs describe actions of users on that third-party system.

### BRIEF DESCRIPTION OF THE FIGURES

FIG. 1 is a block diagram illustrating a specific embodiment of a computing device that is connected to a network of devices, in accordance with some embodiments.

FIG. 2 illustrates an example system environment for an online system, in accordance with some embodiments.

FIG. 3 illustrates dataflow through a system environment of an online system, in accordance with some embodiments.

FIG. 4 illustrates dataflow through another system environment of an online system, in accordance with some embodiments.

FIG. 5 illustrates dataflow through another system environment of an online, in accordance with some embodiments.

FIG. 6A illustrates an example process for training a machine-learning model to predict whether a user's interaction complies with a set of constraints associated with an entity, in accordance with some embodiments.

FIG. 6B is an example flowchart illustrating how an expense management system may use a machine-learning model to predict whether a user's interaction complies with a set of constraints associated with an entity, in accordance with some embodiments.

FIG. 7 is a flowchart for an example method for training a constraint prediction model, in accordance with some embodiments.

### DETAILED DESCRIPTION

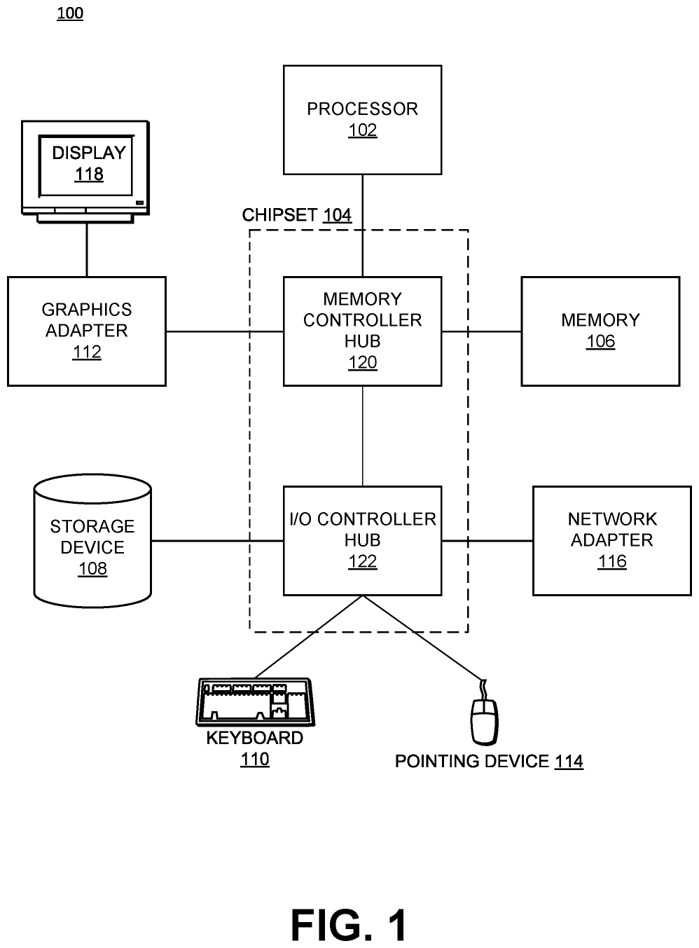

FIG. 1 is a block diagram illustrating a specific embodiment of a computing device 100 that is connected to a network of devices, in accordance with some embodiments. The example computing device 100 includes at least one processor 102 coupled to a chipset 104. References to a processor (or any other component of the computer 100) should be understood to refer to any one such component or combination of such components working cooperatively to provide the described functionality. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 have different architectures.

In the embodiment shown in FIG. 1, the storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, touchscreen, or other type of pointing device, and may be used in combination with the keyboard 110 (which may be an on-screen keyboard) to input data into the computer system 100. The graphics adapter 112 displays images and other information on the display 118. The network adapter 116 couples the computer system 100 to one or more computer networks, such as network 230.

### Configuration Overview

The management by a company of business-related expenses incurred by its employees is a difficult, time-consuming, and expensive process, especially for large organizations or companies where users may do many different types of business-related spending, or where the business expenses tend to be complex. One example is for companies where the employees travel frequently, and so there are a multitude of travel expenses in addition to other corporate expenditures. Typically, business expenses are (1) either paid by the employee and submitted for reimbursement later or (2) charged to a specific company-managed credit card or to a few common company cards that bear most of the expenses for the entire company across many categories of expenses.

In the latter situation, corporate credit cards may be issued to an individual user within a company, and depending on company policy, the cards may be used for multiple different types of purchases, and sometimes for numerous uses. For example, employees may use the cards for expenditures related to a company party, for business lunches, or to purchase travel bookings across multiple employees and multiple trips. This leads to a long list of transactions that require significant time and effort to untangle, attribute, and categorize at the end of each statement period, in a reconciliation process that is generally required by companies' accounting policies. Using this system, the company is still open to liability from purchases made out of policy, but since the cards were given to the employee and there is no enforcement of policy at the point of sale (POS), there is little recourse for the company but to either let the violating purchase stand or to pursue reimbursement from the employee. Neither course is optimal for either sound financial policy or healthy employee relations.

Some systems may overcome these challenges by “issuing” their own corporate credit cards by underwriting corporate credit cards issued by a bank. By underwriting and managing transactions for the underlying issuer, the systems can gain access to transaction information for the corporate credit cards and authorize or decline transactions that do not comply with expense policies. However, this approach generally requires the system to maintain a large line of credit with a bank to cover the underwriting, which comes with additional funding costs (normally in the form of interest payments on a securitized loan that enables the issuing practice). Additionally, the system is exposed to the potential loss from users who do not repay the system for the transactions that they placed on their credit cards.

Therefore, there is a need to address challenges facing companies in managing corporate expenses.

An entity (e.g., a company or an organization) can use an expense management system to manage their expenses. The expense management system dynamically manages expenses that a user puts on their corporate credit card by applying expense policies from the entity to each transaction the user incurs. For example, when a user uses their corporate credit card for a transaction, the card network system sends transaction information describing the transaction to the expense management system. The expense management system automatically applies the expense policies from the entity to the transaction and notifies the user of whether the transaction is covered by the expense policies (e.g., by transmitting a notification to the user's device). The expense management system may receive up-to-date information describing the user's calendar or travel to determine whether a user's transaction is covered. For example, if an entity's expense policy is to give a user a $200 per diem while the user is traveling, the entity may transmit the user's travel plans to the expense management system, and the expense management system may automatically approve transactions on the user's corporate credit card up to the $200 limit per day during the time period that the user is on business travel.

The expense management system thereby simplifies expense management for entities by handling expenses on the entity's corporate credit cards immediately and automatically. It reduces the need for users to manually submit requests for expenses to be reimbursed or to explain transactions on their corporate credit cards. Additionally, because users using corporate credit cards are immediately notified of whether their transactions comply with the entity's expense policies, these users are less likely to incur significant non-covered expenses on the corporate credit cards, thereby reducing the likelihood that the entity is liable for significant, unexpected expenses. The dynamic notification to users also reduces how much and how often the entity must try to collect improper expenses from the users, which improves their relationships with their employees.

In some embodiments, the expense management system can use domain control rules applied by a card network system to enforce an entity's expense policies before the transaction is completed. Card network systems can constrain attempted transactions on credit cards in accordance with domain control rules. These domain control rules can limit transactions based on merchant, merchant categories, amount of money, or geographic location.

The expense management system can update the domain control rules applied by the card network system for corporate credit cards associated with an entity through APIs that the card network system makes available to the expense management system. The expense management system converts the expense policies from the entity into domain control rules for the card network system to apply. Since an entity's expense policies tend to be more sophisticated than the generic rules applied by the card network system, the expense management system may combine a set of domain control rules together such that the card network system functionally applies the expense policies of the entity. For example, if an expense policy prohibits expenses within a geographic area during a particular time period, the expense management system may activate and deactivate domain control rules that prohibit a credit card from being used within the geographic area such that transactions are functionally prohibited only during the time period specified by the expense policy.

By using the card network system's domain control rules to enforce an entity's expense policies, a transaction that is not covered by the entity's expense policies is not incurred in the first place. Thus, a user with a corporate credit card associated with the entity cannot incur improper expenses on the entity's behalf. Similarly, the use of a card network system's domain control rules reduces the likelihood that the entity must seek reimbursement from the user for an improper transaction on a corporate credit card because the domain control rules prohibit transactions from occurring at all when the transactions do not comply with the entity's policies. Thus, an entity can maintain better relationships with their employees.

In some embodiments, the expense management system can automatically identify corporate expenses on a user's personal credit card and reimburse the user for the corporate expenses if the expenses comply with the entity's expense policies. In these embodiments, the expense management system receives transaction information for transactions on a user's personal credit card and determines whether each transaction is one that the user incurred on behalf of the entity. For these corporate expenses, the expense management system determines whether the transaction complies with the entity's expense policies and notifies the user about whether the transaction is covered. If the transaction is covered, the expense management system may coordinate a reimbursement to the user for the transaction.

By enabling the automatic reimbursement of corporate expenses on a user's personal credit card, the expense management system improves both the user's experience and the entity's management processes. Since the user can execute transactions on their personal credit cards, the user receives rewards from the credit card issuer for using their personal credit card without having to incur the expense themselves. Additionally, since the expense management system automatically reimburses the user, the user can maintain the benefits of using their personal credit cards without having to manually submit a request for reimbursement. For the entity, the liability for the transaction remains with the user until the transaction is determined to be covered by the entity's expense policies. Thus, the entity is less likely to be liable for an expense that is not covered under their expense policies and is less likely to have to request a reimbursement for the transaction from the user, thereby improving their relationships with their employees or members.

### System Environment

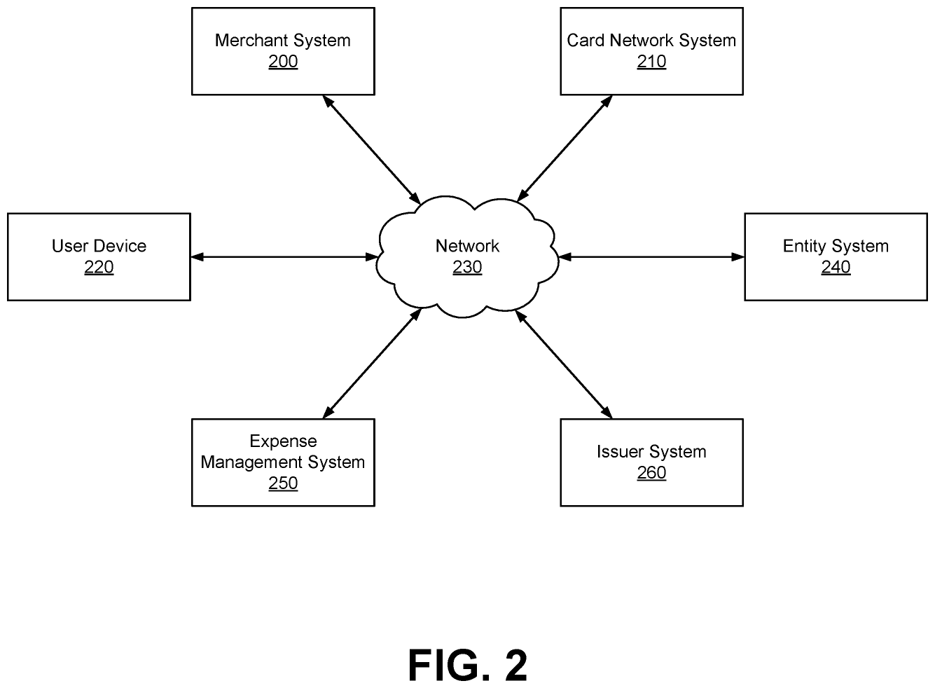

FIG. 2 illustrates an example system environment for an expense management system 250, in accordance with some embodiments. The system environment illustrated in FIG. 2 includes a merchant system 200, a card network system 210, a user device 220, a network 230, an entity system 240, an expense management system 250, and an issuer system 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The merchant system 200 is a computing system that receives credit card payment information from a user or cardholder for a transaction between a merchant and the user. The merchant system 200 also requests payment to the merchant for the transaction from the issuer system 260 via the card network system 210. Specifically, in a typical example of a credit card environment, the user's card details are sent from the merchant to a bank associated with the merchant (e.g., the acquiring bank or merchant's bank), which forwards those details to the card network system 210 (e.g., Visa, Mastercard, American Express, or Discover), which clears the payment and requests payment authorization from the issuer system 260 (e.g., the credit card issuing bank, or the bank that issued the credit card to the user). The payment information received by the merchant system 200 includes an identifier for a credit card account with the issuer to be used for paying for the transaction. For example, the payment information may include one or more of the following: a credit card number, a card verification value, an expiration date, a name associated with the credit card account, a billing address, a card security code, a payment amount, among other details. For simplicity, the description herein will focus primarily on embodiments using a credit card for payment to a merchant. However, other payment methods may be used in these or other embodiments.

The card network system 210 is a computing system that facilitates payments from users to merchants through credit cards. Examples of card network systems 210 include systems with networks that process credit card payments worldwide and govern interchange fees, such as Visa, Mastercard, American Express, and Discover. The card network system 210 includes hardware systems that receive and transmit transaction information, and includes software systems that process transactions and ensure the validity of the transactions. Transaction information is information that describes a transaction between the user and the merchant. For example, transaction information may include a payment amount, time, currency, credit card number, the payment information from the credit card, a merchant identifier, or a merchant category.

The card network system 210 may provide transaction information for a transaction to the issuer system 260 for the issuer system 260 to approve. If the issuer system 260 approves the transaction, the card network system 210 coordinates the payment from the user's account at the issuer to a merchant's account at another institution (e.g., an acquiring bank). The card network system 210 may enforce domain control rules for credit cards, which are constraints on how a user can use their credit card. The card network system 210 may also notify entities that are third parties to a transaction of the details of a transaction. The system described here provides an advantage over conventional systems in that there is an expense management system that dynamically manages expenses, and so the card network system 210 may provide transaction information to the expense management system 250 for transactions associated with credit cards managed by the expense management system 250. The domain control rules and notifications to the expense management system 250 are described in further detail below.

A user can interact with other systems through a user device 220. The user device 220 can be a personal or mobile computing device, such as a smartphone, a tablet, a laptop computer, or desktop computer. In some embodiments, the user device 220 executes a client application that uses an application programming interface (API) to communicate with other systems through the network 230.

The user corresponding to the user device 220 may be assigned a corporate credit card by the entity corresponding to the entity system 240. The corporate credit card is a credit card that is issued by the issuer to the user associated with the entity or that is issued to the entity to be used by the user. For example, the user may be an employee of the entity (e.g., a corporation, company, or organization) and the user may use the credit card to purchase goods and services on behalf of the entity. However, the entity may have one or more expense policies that restrict or define specific parameters around the goods or services that the user can purchase using the card. For example, the expense policy may limit from which merchants the user may purchase goods or services, when the user may use the credit card, or in which geographic locations or areas the user may use the credit card. The expense policy for an entity may be managed and enforced by the expense management system 250, as described in further detail below.

The user device 220 receives policy results for the user's transactions that were processed by the expense management system 250. These policy results indicate whether the user's transaction was covered by the entity's expense policy. These results can be received in real-time or near real-time. For example, the user device 220 can be notified on a mobile application or via another notification mechanism at the point of sale (e.g., during or after the user has swiped the credit card at the merchant) certain details about the transactions. For example, the user may be notified that the transaction has been approved or denied, the notification may specify certain details around the policy that will be violated by the transaction (e.g., the transaction will exceed the policy limit for that particular type of purchase or that type of merchant). In some embodiments, the transaction proceeds even if it violates an expense policy. If the user's transaction proceeded but was not covered by the entity's expense policy, the policy results may further indicate that the user must reimburse the entity for the transaction. In other embodiments, the transaction is blocked or prevented based on the violation of the entity's expense policy. In this example, the user may receive a notification as to why the transaction is not going through, and may modify the transaction (e.g., reduce the amount being spent such that it falls under an expense policy limit, or purchase a different item that falls under the policy requirements, etc.). More details about the dynamically applied policies are included below.

The network 230 is a collection of computing devices that communicate via wired or wireless connections. The network 230 may include one or more local area networks (LANs) or one or more wide area networks (WANs). The network 230, as referred to herein, is an inclusive term that may refer to any or all of standard layers used to describe a physical or virtual network, such as the physical layer, the data link layer, the network layer, the transport layer, the session layer, the presentation layer, and the application layer. The network 230 may include physical media for communicating data from one computing device to another computing device, such as MPLS lines, fiber optic cables, cellular connections (e.g., 3G, 4G, or 5G spectra), or satellites. The network 230 also may use networking protocols, such as TCP/IP, HTTP, SSH, SMS, or FTP, to transmit data between computing devices. In some embodiments, the network 230 may include Bluetooth or near-field communication (NFC) technologies or protocols for local communications between computing devices. Similarly, the network 230 may use phone lines for communications. The network 230 may transmit encrypted or unencrypted data.

The entity system 240 is a computing system operated by an entity. The entity may be a business, organization, or government, and the user may be an agent or employee of the entity. The entity system 240 provides an interface to other employees of the entity (e.g., expense administrators, accounts team members, etc.) to specify expense policies for the user's corporate credit card, and transmits the expense policies to the expense management system 250. The entity system 240 also may receive policy results from the expense management system 250 that indicate whether a user's transaction is covered by the expense policies set by the entity. These policy results can be presented in an interface to, for example, expense administrators or accounts team members that manage adherence to those policies. These policy results may also indicate whether the entity system 240 is reimbursed by the user or whether the entity system 240 reimburses the user. While the entity system 240 is primarily described herein as being separate from the expense management system 250, the entity system 240 may perform some or all of the functionality of the expense management system 250. In some embodiments, the expense management system 250 is provided by another party, and the entity subscribes to the expense management system 250 through that other party so that the entity is able to use the system 250 to dynamically manage its expenses. In other embodiments, another party may provide software that the entity can purchase or use to provide the expense management system 250 functionality within the entity system 240.

The expense management system 250 is a computing system that manages expenses incurred for an entity by users. The expense management system 250 receives expense policies from the entity system 240, which constrain or define limits or parameters around the transactions that a user may expense to the entity using their corporate credit card from the entity. For example, the expense policies may include a per diem, a lodging budget, a rail travel budget, a flight budget, limitations on merchants or merchant categories at which the credit card can be used, or limitations on geographic regions or locations in which the card can be used. The expense management system 250 receives transaction information from the card network system 210 and determines whether the transaction described by the transaction information complies with the expense policies from the entity system 240. The expense management system 250 transmits policy results to the user through the user device 220 and to the entity through the entity system 240. These results indicate whether a transaction complies with the expense policies of the entity. If the transaction does not comply with the expense policy, the expense management system 250 may approve or reject the transaction, ask for additional information about the transaction (e.g., request that the user take a photo of a receipt for the transaction, request that the user provide a note describing the transaction or a purpose of the transaction, request that the user identify other users that were associated with the transaction), transmit a request to the user device 220 for the user to reimburse the entity for the transaction, allow the user to contest the approval or rejection, only provide a partial reimbursement, among other possibilities.

In some embodiments, the expense management system 250 uses data feeds from the card network system 210 to receive transaction information from the card network system 210 for credit cards associated with the entity. The expense management system 250 may request a first data feed from the card network system 210. This first data feed provides the expense management system 250 with entity data that identifies which credit cards are registered with an entity and a list of settled transactions that have been recorded for that entity. For example, the expense management system 250 may request Visa Commercial Format (VCF) from Visa or Common Data Format 3 (CDF3) files from MasterCard. The expense management system 250 uses the entity data from the first data feed to identify the credit cards that are registered with the entity.

Using the entity data from the first data feed, the expense management system 250 requests transaction information from the card network system 210 via a second data feed. The second data feed provides the expense management system 250 with transaction information as the card network system 210 services transactions placed on a user's credit card. For example, the second data feed may include the Visa Offer Platform (VOP) from Visa or the Real Time Transaction Notification (RTTN) from MasterCard. The second data feed may be credit card specific, and the expense management system 250 may have to create a second data feed for each credit card associated with the entity. A second data feed may be a read-only data feed, meaning that the expense management system 250 may be limited to receiving transaction information through the second data feed and unable to use the second data feed to authorize or decline transactions. Furthermore, in some embodiments, the expense management system 250 may provide registration information for each credit card for which the expense management system 250 is accessing a second data feed. The expense management system 250 may extract the registration information for an entity's credit card from the entity information received from the first data feed.

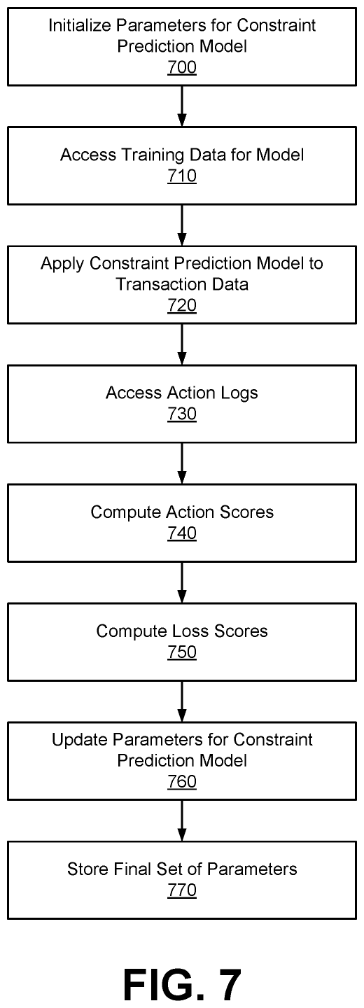

In some embodiments, the expense management system 250 uses a machine-learning model to predict whether transactions comply with an entity's expense policies. The expense management system 250 may train a constraint prediction model to predict the likelihood that a transaction complies with the constraints of the expense policies. For example, the expense management system may train the constraint prediction model using an action-based loss function, as described below with regards to FIG. 7.

The issuer system 260 is a computing system for an issuer of the user's credit card. The issuer may be an entity that issues a line of credit for the user or for the entity to use for the credit card. The issuer system 260 receives transaction information from the card network system 210 and may approve or reject payments to the merchant for the transaction.

### Example Dataflow for Expense Management System

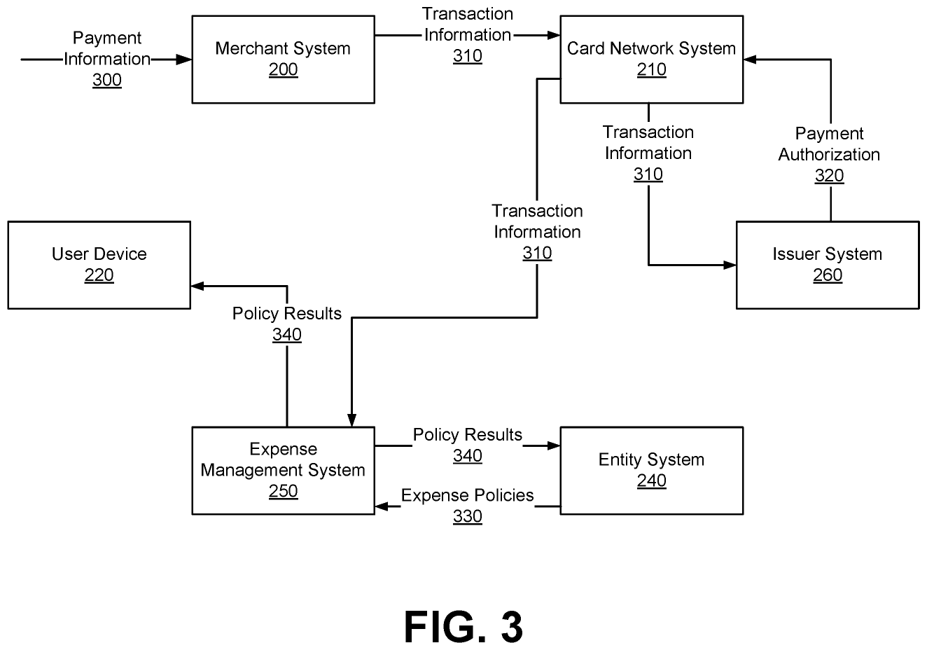

FIG. 3 illustrates dataflow through a system environment of an example expense management system 250, in accordance with some embodiments. Alternative embodiments may include more, fewer, or different components from those illustrated in FIG. 3, and the described functionality of each component may be performed by different components in the system environment. Additionally, each component may perform its respective functionality automatically or in response to human instruction.

The merchant system 200 receives payment information 300 for a transaction. The payment information includes the account number associated with a credit card used by a user. The merchant system 200 may receive the payment information using the credit card's magnetic strip, an embedded microchip on the credit card, or an RFID chip on the credit card. In some embodiments, the merchant system 200 receives the payment information from the user device 220.

The merchant system 200 transmits transaction information 310 for the transaction to the card network system 210. As explained above, this transmission may first go to a merchant or acquiring bank, and then to a card network system 210. The transaction information 310 describes the transaction between the user and the merchant. The card network system 210 transmits the transaction information 310 to the issuer system 260. The issuer system 260 may verify the transaction information 310, such as to determine whether the transaction is fraudulent and determine whether the transaction information 310 has sufficient information to perform the transaction. If the issuer system 260 verifies the transaction information 310, the issuer system 260 transmits a payment authorization 320 to the card network system 210 to pay the merchant for the transaction.

The card network system 210 also transmits the transaction information 310 to the expense management system 250, and the expense management system 250 determines whether the transaction is covered by expense policies 330 from the entity system 240. The expense management system 250 transmits policy results 340 to the user device 220 and the entity system 240. The policy results 340 indicate whether the transaction is covered by the expense policies 330. For example, the policy results 340 may indicate that the transaction was approved or rejected by the expense management system 250. Thus, both the entity and the user are made aware of whether a transaction complies with the expense policies 330 at the time of the transaction, rather than when a monthly statement for the credit card is processed.

If the expense management system 250 determines that the transaction is not covered by the expense policies 330, the expense management system may notify the user that the expense is not covered. For, example, the expense management system 250 may include with the policy results 340 an indication that the user must reimburse the entity for the transaction or for a portion of the transaction. The user device 220 may display the policy results 340 to the user. Thus, the transaction may be found to violate expense policies at the point of the transaction occurring, and the user may be notified of this so that the user is aware that the company will not cover the expense associated with that transaction (or may cover the expense up to a limit). In this embodiment, the transaction can still go through and the expense management system 250 may not block the user from completing the transaction, but the user is made aware that it does not meet a policy and the user will need to reimburse the entity.

In some embodiments, the entity system 240 provides additional information about the user to the expense management system 250 for the expense management system 250 to dynamically determine whether a transaction is covered by the expense policies. For example, the entity system 240 may provide calendar data for the user's calendar that indicates whether the user is at a work event (e.g., at a work client meeting, at a work social event, etc.) at the time that the transaction occurred such that the transaction would count as a work-related transaction that is covered by an expense policy. For example, if the user purchases a food item during a three-hour window where the user's calendar indicates that the user is meeting with a client or partner company, the expense may be automatically determined by the expense management system 250 to be a work-related expense that is covered as long as it falls under any spending limits for such meetings. Similarly, the entity system 240 may provide travel data to the expense management system 250 that indicates when the user is traveling for business, so that the expense management system 250 can determine whether the transaction occurred while the user was on a work trip and whether it meets one or more work travel expense policies (e.g., travel per diems, approved type of purchase for travel or approved merchants, etc.). The expense management system 250 may determine that user is on a work-related trip based on the user's calendar, based on the entity providing this information, or even based on integration with a travel booking system from which the user or entity booked the user's trip. As an example, if the user purchases meals during a time in which the user is determined by the expense management system 250 to be on a work trip, these meals may be automatically counted as work related expenses as long as they meet per diem requirements. However, if the user were to purchase a pair of shoes during the trip, this may be determined to not meet a work-trip related expense policy. Other data that the entity system 240 may provide to the expense management system 250 includes email data (e.g., confirmation emails for travel/hotel bookings), project data (e.g., data describing projects being undertaken by the entity that may require a user to travel), and transaction estimates for the user.

### Example Dataflow for Expense Management System Using Domain Control Rules

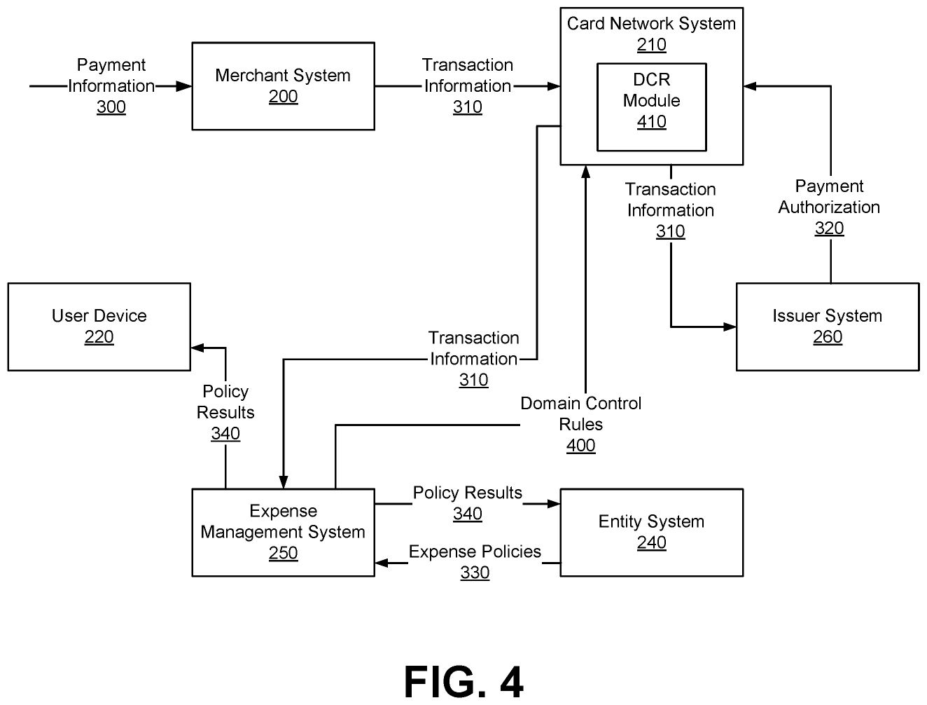

FIG. 4 illustrates dataflow through another system environment of an example expense management system 250, in accordance with some embodiments. Alternative embodiments may include more, fewer, or different components from those illustrated in FIG. 4, and the described functionality of each component may be performed by different components in the system environment. Additionally, each component may perform its respective functionality automatically or in response to human instruction.

The data flow in FIG. 4 is similar to the data flow illustrated in FIG. 3. However, in FIG. 4, the expense management system 250 provides domain control rules (DCR) 400 to the card network system 210 for execution by a DCR module 410. The domain control rules 400 are rules used by the rules module 410 to constrain transactions on certain credit cards at the card network system 210. Example domain control rules 400 for a credit card may include restrictions on merchant categories for merchants at which the credit card can be used, restrictions on time periods during which the credit card may be used, blacklisting or whitelisting of merchants, or restrictions on geographic locations or areas within which the credit card may be used. Domain control rules may be established on a card-by-card basis or for a set of cards.

The DCR module 410 restricts transactions that do not comply with the domain control rules 400 established for the corresponding credit card. For example, if a domain control rule 400 restricts the user to merchants in a restaurant merchant category and the user uses the credit card at a clothing store, the DCR module 410 may prohibit the transaction from going through. Unlike the embodiment in FIG. 3 where the transaction still proceeds even though the user is notified of a policy violation, in this embodiment the transaction may be prevented from proceeding.

The expense management system 250 translates or converts expense policies 330 received from the entity system 240 into domain control rules 400 for the DCR module 410 to enforce. The expense policies 330 may include more sophisticated rules than what the domain control rules 400 specify. For example, while the domain control rules 400 may allow an entity to restrict a merchant category with a single rule, the domain control rules 400 may not allow the entity to use a single rule to restrict the user from using the credit card at the merchant category outside of a certain time period and outside of a given geographic area. Thus, the expense management system 250 converts each expense policy 330 into a set of domain control rules 400 that, together, enforce the expense policy 330. For example, if the expense management system 250 wants to restrict a merchant category outside of a time period, the expense management system 250 may initially transmit domain control rules 400 to the DCR module 410 that prohibit the merchant category. Once the time period starts, the expense management system 250 transmits new domain control rules 400 that allows the credit card to be used at the merchant category, and once the time period ends, the expense management system 250 transmits domain control rules 400 that prohibit the credit card from being used at the merchant category again.

The expense management system 250 may use a mapping of possible expense policies 330 to domain control rules 400 to convert or translate the expense policies to domain control rules 400. The mapping may map each possible expense policy to a set of domain control rules 400 that cause the card network system 210 to implement the expense policy. The expense management system 250 may thereby convert the expense policies 330 received from the entity into domain control rules 400 by determining which set of domain control rules corresponds to each of the expense policies 330 that the expense management system 250 receives.

The expense management system 250 transmits the domain control rules 400 to the DCR module 410 for the DCR module 410 to enforce. In some embodiments, the expense management system 250 uses an API made available by the card network system 210 to transmit the domain control rules 400.

Thus, the expense management system 250 provides a sophisticated management of the policies and translation into controls that can be simply applied at the card network system 210 without the card network system 210 having to have any understanding of the nuances of the rules. This complex management ability of the expense management system 250 allows the entity to set a multitude of different policies specific to the entity's own needs. The system 250 manages all these policies and translates them into controls that are applied by the card network system 210, so the entity simply sees a seamless and automated application of its policies by the credit card network 210, even though the expense management system 250 is pulling the strings and managing the actual policy application.

Additionally, by using the domain control rules 400 to enforce the expense policies 330 at the card network system 210, the expense management system 250 essentially reconfigures an existing credit card into a functionally new credit card as applied by the card network system 210. Thus, the overall system is more robust because the card network system 210 will continue to enforce the entity's expense policies if the expense management system 250 is offline.

### Example Dataflow for Expense Management System for Personal Credit Cards

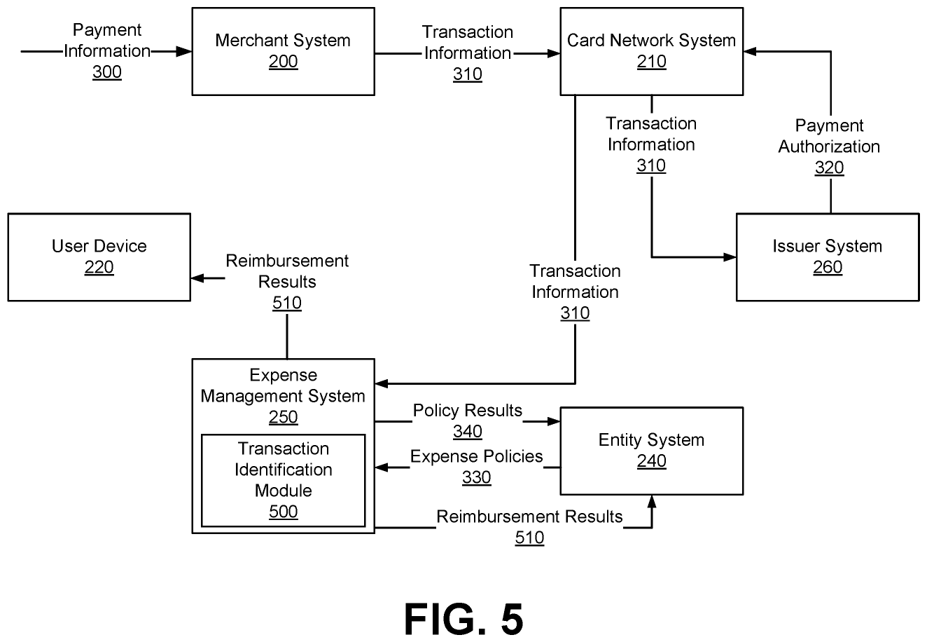

The embodiments described above have primarily described a user using a corporate credit card issued to the entity or to a user on behalf of an entity. However, an expense management system 250 may be used to identify corporate transactions that have been made using a user's personal credit card, as illustrated in FIG. 5. The expense management system 250 can then reimburse the user for the corporate transaction.

FIG. 5 illustrates dataflow through another system environment of an example expense management system 250, in accordance with some embodiments. Alternative embodiments may include more, fewer, or different components from those illustrated in FIG. 5, and the described functionality of each component may be performed by different components in the system environment. Additionally, each component may perform its respective functionality automatically or in response to human instruction.

The data flow in FIG. 5 is similar to the data flow illustrated in FIGS. 3 and 4. However, in FIG. 5, the user is using a personal credit card, rather than a credit card issued to the entity for use by the user or issued to the user on behalf of the entity. The user can, for example, link or register a personal credit with the expense management system 250 so that the card can then be used by the user for business expenses. But since these transactions are managed by the expense management system 250, the user does not have to submit an expense reimbursement later for those business expenses on the personal credit card. Instead, the expense management system 250 can provide information to the entity about those work expenses so the entity can automatically reimburse the user (e.g., reimbursement in the user's next paycheck). The user can, at the time of the transaction, denote that an expense is a business expense, so that it is automatically sent by the expense management system 250 for reimbursement by the entity assuming the expense management system 250 determines it meets the entity's expense policies. The expense management system 250 also may include a transaction identification module 500 that itself automatically identifies which transactions on a user's personal credit card were transactions that were made on behalf of the entity and determines whether those transactions are covered by the expense policies 330 from the entity. Entity-based transactions can be displayed to the entity on an interface or dashboard provided by the expense management system 250 for the entity to view and manage.

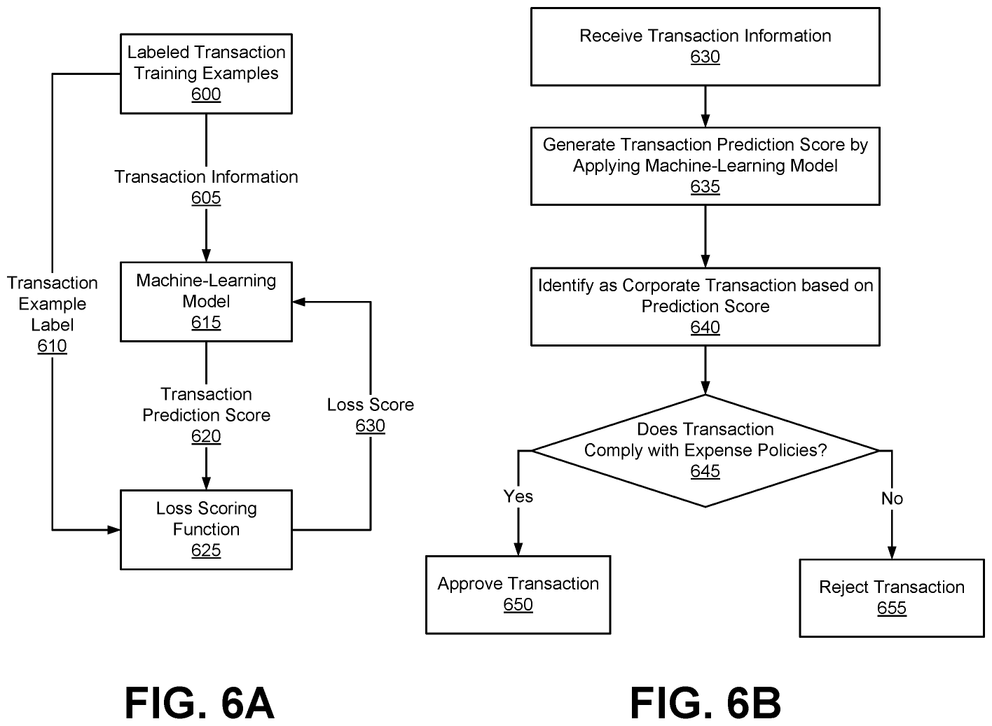

The transaction identification module 500 thus receives transaction information 310 from the card network system 210 and uses the transaction information 310 to determine whether the transaction corresponds to a transaction for the entity. The transaction identification module 500 may apply a set of identification rules to the transaction information 310 to determine whether the transaction is for the entity. The transaction identification module 500 also may use machine-learning model (e.g., a classifier) that has been trained to identify whether a transaction was made by the user for the entity. The training and use of a machine-learning model is described in more detail below with regards to FIGS. 6A and 6B. As described above, the transaction identification module 500 may also receive additional information describing the user to determine whether a transaction is a corporate transaction. For example, the transaction identification module 500 may receive calendar data or travel data from the entity system 240 and may use that data to determine whether a transaction is a corporate one. Once the transaction identification module 500 determines that the transaction is a corporate transaction, the expense management system 250 applies expense policies 330 from the entity system 240 to determine whether the transaction is covered by the expense policies 330, as described herein.

The expense management system 250 transmits reimbursement results 510 to the user device 220 and the entity system 240. The reimbursement results 510 indicate whether the entity will reimburse the user for the transaction. The user device 220 may present the reimbursement results 510 to the user, thereby indicating whether the user will be reimbursed by the entity.

In some embodiments, the expense management system 250 may be authorized by the user to prohibit transactions on the user's personal credit card that the expense management system 250 determines as likely to be a corporate transaction but that are not covered by the expense policies 330. For example, the user may authorize the expense management system 250 to control which transactions can be performed on the user's personal credit card (e.g., using domain control rules as described above). If, as described above, the expense management system 250 determines that a transaction is a corporate transaction but not covered by the expense policies 330, the transaction is prohibited by the expense management system 250 or the card network system 210. The expense management system 250 may notify the user through the user device 220 that the transaction was rejected and give the user the option to override the rejection by acknowledging that the transaction will not be covered by the entity. The user may be able to override the rejection through a phone call, a text message, or through a client application operating on the user device 220. The user also may be allowed to take an additional action that allows the transaction to be covered by the expense policies 330. For example, if the user is at a business dinner but forgot to update their calendar to indicate that they have a business dinner, the user may be able to indicate, through the notification of rejection of the transaction, that they are at a business dinner and thus the transaction should be covered under the expense policies 330.

FIG. 6A illustrates an example process for training a machine-learning model to predict whether a transaction on a user's personal credit card is a corporate transaction for an entity, in accordance with some embodiments. The expense management system uses a set of labeled transaction training examples 600 to train the machine-learning model 615. Each of these examples 600 includes transaction information 605 for a transaction from a user's personal credit card and a transaction example label 610 that indicates whether the transaction was a personal transaction or a corporate transaction. The expense management system applies the machine-learning model 615 to the transaction information 605 to generate a transaction prediction score 620, which represents a likelihood that the transaction is a corporate transaction. This prediction score 620 is compared to the transaction example label 610 using a loss scoring function 625 to generate a loss score 630 for the training example. The expense management system uses the loss score 630 to update the machine-learning model 615 (e.g., using backpropagation). The expense management system repeats this process for each example in the set of examples 600 to generate the trained machine-learning model.

FIG. 6B is an example flowchart illustrating how an expense management system may use a machine-learning model to predict whether a transaction on a user's personal credit card is a personal transaction or a corporate transaction, in accordance with some embodiments. The expense management system receives 630 transaction information that describes a transaction on a user's personal credit card and generates 635 a transaction prediction score by applying a machine-learning model to the transaction information. The machine-learning model may be trained to predict whether a transaction on is a personal or corporate transaction based on transaction information for the transaction (e.g., as described for FIG. 6A). The expense management system identifies 640 the transaction as a corporate transaction based on the prediction score (e.g., if the prediction score exceeds a threshold value) and determines 645 whether the transaction complies with expense policies for an entity. If the transaction does comply with the expense policies, the expense management system approves 650 the transaction and may coordinate a reimbursement to the user for the transaction. However, if the transaction does not comply with the expense policies, the expense management system 655 rejects the transaction and the user is not reimbursed for the transaction.

### Example Method for Training a Constraint Prediction Model Using an Action-Based Loss Function

FIG. 7 is a flowchart for an example method for training a constraint prediction model, in accordance with some embodiments. Alternative embodiments may include more, fewer, or different steps from those illustrated in FIG. 7, and the steps may be performed in a different order from that illustrated in FIG. 7. The steps of the method may be performed entirely by one computing device or system or may be divided among multiple computing devices or systems. Furthermore, the steps may be performed automatically with or without human interaction.

As described above, the expense management system may use a machine-learning model to predict whether a transaction on a corporate credit card complies with the expense policy of a company. The model may be referred to herein as the “constraint prediction model,” as the model predicts whether a transaction is in compliance with the constraints of the expense policy. More specifically, a constraint prediction model outputs a predicted likelihood that a transaction is in compliance with constraints of an entity's expense policy and the expense management system uses thresholds for the predicted likelihood to determine how to proceed. For example, if the predicted likelihood is above a high threshold, the expense management system may automatically approve the transaction. Similarly, if the predicted likelihood is below a low threshold, the expense management system may automatically deny the transaction.

In some cases, however, a predicted likelihood may not provide a strong indication of whether a transaction complies with an entity's expense policies. For example, the predicted likelihood may be between two thresholds for making an automatic determination of whether a transaction is in policy. In these cases, the expense management system may prompt the user associated with the transaction for additional information describing the transaction or may prompt a human reviewer to review the transaction information describing the transaction to make a determination. While these actions by the expense management system will generally lead to more accurate determinations, they are also less efficient methods of making the ultimate determinations on whether transactions are in policy because they require human interactions with the overall process. Therefore, the expense management system benefits where the constraint prediction model generates predicted likelihoods with more certainty regarding corresponding transactions.

One way to improve a constraint prediction model's certainty with a greater number of transactions is to provide additional training data to the constraint prediction model with ground truth labels that indicate whether transactions described in the training data are in or out of compliance. The expense management system may use a loss function that penalizes the constraint prediction model based on a difference between a predicted likelihood and a corresponding ground truth label. However, where the constraint prediction model is trained based on real examples where the expense management system had to request additional information from the user or require human review of the transaction information, the constraint prediction model may appear to be successful but actually required significant additional resources to make a determination on the compliance of a transaction with an entity's expense policies. In fact, because this additional information improves the model's performance, the model may unintentionally be trained to generate likelihoods that indicate a higher uncertainty until the model more information than necessary, which may cause the constraint prediction model to still require significant human resources to make determinations on whether transactions comply with expense policies.

To address this problem, the expense management system may train the constraint prediction model using an action-based loss function. The action-based loss function is a loss function that penalizes the constraint prediction model for predictions that require the operators of the expense management system to perform to confirm whether the transaction is in policy or out of policy.

To train the constraint prediction model, the expense management system initializes 700 parameters for the constraint prediction model by, for example, setting an initial set of default values for parameters of the constraint prediction model.

The expense management system accesses 710 training data for the constraint prediction model. The training data includes a set of training examples of transactions that have been placed on a corporate credit card. More specifically, each training example includes transaction information that describes a transaction between a user and a merchant using a corporate credit card of an entity. The transaction information may include a payment amount, time, currency, credit card number, the payment information from the credit card, a merchant identifier, or a merchant category. In some embodiments, the transaction information relates to a user's personal credit card, and the expense management system uses the constraint prediction model to predict whether expenses on the user's personal credit cart are corporate expenses and therefore reimbursable.

Each training example also includes a label that indicates whether the transaction is in policy for a company associated with the transaction. The label may be created for training examples in the ordinary course of the expense management system assigning transactions as in policy or out of policy for a company. For example, as mentioned above, an expense management system may use human operators or a rules-based approach to determine whether transactions on corporate credit cards are in policy for an associated company. The expense management system may use the determinations made using these techniques as labels for transactions as the expense management system processes the transactions.

The expense management system applies 720 the constraint prediction model to the transaction information of each of the training examples to generate constraint predictions for the training examples. A constraint prediction is a predicted likelihood that a transaction is in policy for a company. For example, a constraint prediction may be a score from zero to one that represents this likelihood. In some embodiments, the training examples include additional information that may indicate whether a transaction is in-policy, and the expense management system may apply the constraint prediction model to that additional information as well as the transaction information. For example, the training examples may include calendar data that describes the user's calendar, travel data describing the user's travel, email data, project data, and transaction estimates.

The expense management system accesses 730 action logs describing actions taken by users with regards to the transactions in the training examples. The actions in these action logs are ones taken by the user associated with the transaction or other users associated with the entity or the expense management system (e.g., accounting personnel) to complete a review of the transaction and whether the transaction complies with the constraints of the expense policy. For example, actions taken by the user associated with the transaction may include submitting the transaction, writing a description of the transaction, or communicating with another user associated with the expense management system or the entity to resolve the transaction. Similarly, actions taken by other users (e.g., those associated with the expense management system or the entity) may include a manual review of the transaction information or the user's description, communications with the user associated with the transaction, or accessing other information associated with the transacting user (e.g., travel information) to confirm that the transacting user has complied with expense policies. The expense management system may receive the action logs from the entity system or the user device. The expense management system also may generate action logs as users interact with the expense management system.

These action logs may also include actions taken as a consequence of the constraint prediction model being uncertain regarding whether a transaction is in compliance with expense policies. If the constraint prediction model generates a predicted likelihood of compliance that is between an upper and lower threshold used for automatically resolving whether a transaction is in compliance, the expense management system may request that the user associated with the transaction provide additional information describing the transaction. Alternatively, the expense management system may have a human operator review the transaction information for the transaction to make a determination about whether the transaction is in compliance. The expense management system may continually perform this process until the constraint prediction model generates a predicted likelihood that is no longer between the upper and lower threshold, meaning that the constraint prediction model is certain enough in determining whether a transaction is in compliance that the expense management system can take an automatic action to approve or deny the transaction. The actions performed by users to provide more information or to review transaction information are also described in the action logs.

The expense management system computes 740 action scores for the training examples based on the accessed action logs. An action score for a training example is a score that represents how many actions were performed by users to determine whether the corresponding transaction complies with an entity's expense policy. To compute an action score for a training example, the expense management system may identify actions in the action logs that are associated with the transaction in the training example, and compute a number of the identified actions that are associated with the transaction. In some embodiments, the expense management system scores each of the identified actions and computes an aggregated action score based on the scores of each of the actions. For example, the expense management system may assign a higher score to actions that require significant effort on the part of a user and a lower score to actions that require less effort on the part of a user. The expense management system computes an aggregated score for the transaction by summing the assigned scores for each of the actions associated with the transaction.

As noted above, the expense management system may continually request additional information from the user associated with the transaction until the constraint prediction model generates a predicted likelihood that is sufficiently confident as to whether the transaction is in compliance with the expense policies. The expense management system may assign action scores to each of these actions. In some cases, the expense management system assigns an increasing action score to each subsequent request for more information or human review. In other words, the expense management system may assign greater action scores to actions if they were requested later on in the process of determining whether a transaction is in compliance with the expense policies of an entity. As noted above, these action scores may be aggregated to generate an overall action score for a transaction.

The expense management system computes 750 a loss score for each training example using an action-based loss function. An action-based loss function is a loss function that computes a loss score for a training example based on the constraint prediction model's prediction for the training example, the training example's label, and the action score for the training example. The action-based loss scoring function penalizes the constraint prediction model based on how much constraint predictions differ from their corresponding labels in the training examples. The action-based loss scoring function also penalizes the constraint prediction model based on the action scores such that the constraint prediction model is penalized more greatly when users perform more actions to determine whether a transaction is within an expense policy than when users perform fewer actions. In some embodiments, the action-based loss scoring function computes a weighted sum based on the action score, constraint prediction, and training example label to compute the loss score for a training example.

The expense management system updates 760 the parameters for the constraint prediction model based on the computed loss scores for each training example. To update the parameters, the expense management system backpropagates through the parameters of the constraint prediction model using the computed loss scores. The expense management system may backpropagate for each training example as they are generated or may batch the training examples together. The expense management system stores 770 the final set of parameters for the constraint prediction model to a computer-readable medium, and uses the stored parameters to generate constraint predictions for future transactions received by the expense management system. The expense management system may regularly update the constraint prediction model, as described above, as the expense management system receives additional training data.

In some embodiments, the constraint prediction model generates a single prediction that represents the likelihood that a transaction complies with the set of constraints in an entity's expense policy. Alternatively, the constraint prediction model may be a multiclass classifier that generates a set of predicted likelihoods, where each of the predicted likelihoods is a likelihood that a transaction complies with one of a set of expense policies. Each expense policy of the set of expense policies may have its own set of constraints for a transaction to comply with that policy, and the constraint prediction model generates a predicted likelihood for the expense policy that represents a likelihood that a transaction meets the set of constraints corresponding to that expense policy. The expense management system may take actions with regards to transactions based on the set of predicted likelihoods generated by the constraint prediction model for a transaction. For example, if any of the predicted likelihoods exceed a corresponding threshold, the expense management system may automatically approve the transaction. Where the constraint prediction model is a multiclass classifier, the expense management system may train the constraint prediction model using a similar method to that described above with regards to FIG. 7.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A non-transitory computer-readable medium storing parameters for a constraint prediction model, wherein the parameters for the constraint prediction model are produced by a process comprising:
initializing a set of parameters for the constraint prediction model;
accessing training data for the constraint prediction model, wherein the training data comprises a plurality of training examples, wherein each training example of the plurality of training examples comprises:
interaction data describing an interaction of a user with a third-party system; and
a label for the training example that indicates whether the interaction of the user with the third-party system complies with a set of constraints;
applying the constraint prediction model to the interaction data of each training example of the plurality of training examples to generate a set of constraint predictions for the plurality of training examples, wherein each constraint prediction indicates a predicted likelihood that the interaction of the corresponding training example complies with the set of constraints;
accessing action logs from an online system that describe actions taken by users of the online system to determine whether interactions of the plurality of training examples comply with the set of constraints;
computing an action score for each training example of the plurality of training examples based on the action logs, wherein each action score represents a number of actions taken by operators of the online system to determine whether the interaction of the corresponding training example complies with the set of constraints;
computing a loss score for each of the plurality of training examples by applying an action-based loss function to the constraint prediction, action score, and label for each of the plurality of training examples;
updating the set of parameters for the constraint prediction model through a backpropagation process using the computed loss scores for the plurality of training examples; and
storing a final set of parameters for the constraint prediction model to the computer-readable medium.

2. The computer-readable medium of claim 1, wherein the constraint prediction model comprises a neural network with a plurality of layers, wherein the plurality of layers comprises an input layer, a set of intermediate layers, and an output layer, wherein the input layer is connected to the set of intermediate layers, and the set of intermediate layers are connected to the output layer, and wherein applying the constraint prediction model to the interaction data of a training example comprises:
inputting, to the input layer, a feature vector associated with the interaction data of the training data;
receiving a constraint prediction from the output layer.

3. The computer-readable medium of claim 1, wherein computing the action score for a training example of the plurality of training examples comprises:
identifying a set of actions described in the action logs that are associated with the interaction associated with the interaction data of the training example.

4. The computer-readable medium of claim 3, wherein computing the action score for a training example of the plurality of training examples comprises:
assigning a score to each action of the identified set of actions; and
computing an aggregated score based on the assigned scores.

5. The computer-readable medium of claim 1, wherein applying the action-based loss function to a constraint prediction, action score, and label comprises:
computing a weighted sum based on the constraint prediction and the action score.

6. The computer-readable medium of claim 1, wherein accessing the action logs comprises:
receiving action logs from another third-party system, wherein the action logs describe actions of users on that third-party system.

7. A method comprising:
receiving interaction data from a third-party system describing an interaction of the user with the third-party system;
applying a constraint prediction model to the interaction data by accessing parameters for the constraint prediction model stored by the non-transitory computer-readable medium of claim 1; and
predicting whether the interaction complies with a set of constraints based on the application of the constraint prediction model to the interaction data.

8. A method comprising:
initializing a set of parameters for the constraint prediction model;
accessing training data for the constraint prediction model, wherein the training data comprises a plurality of training examples, wherein each training example of the plurality of training examples comprises:
interaction data describing an interaction of a user with a third-party system; and
a label for the training example that indicates whether the interaction of the user with the third-party system complies with a set of constraints;
applying the constraint prediction model to the interaction data of each training example of the plurality of training examples to generate a set of constraint predictions for the plurality of training examples, wherein each constraint prediction indicates a predicted likelihood that the interaction of the corresponding training example complies with the set of constraints;
accessing action logs from an online system that describe actions taken by users of the online system to determine whether interactions of the plurality of training examples comply with the set of constraints;
computing an action score for each training example of the plurality of training examples based on the action logs, wherein each action score represents a number of actions taken by operators of the online system to determine whether the interaction of the corresponding training example complies with the set of constraints;
computing a loss score for each of the plurality of training examples by applying an action-based loss function to the constraint prediction, action score, and label for each of the plurality of training examples;
updating the set of parameters for the constraint prediction model through a backpropagation process using the computed loss scores for the plurality of training examples; and
storing a final set of parameters for the constraint prediction model to a non-transitory computer-readable medium.

9. The method of claim 8, wherein the constraint prediction model comprises a neural network with a plurality of layers, wherein the plurality of layers comprises an input layer, a set of intermediate layers, and an output layer, wherein the input layer is connected to the set of intermediate layers, and the set of intermediate layers are connected to the output layer, and wherein applying the constraint prediction model to the interaction data of a training example comprises:
inputting, to the input layer, a feature vector associated with the interaction data of the training data;
receiving a constraint prediction from the output layer.

10. The method of claim 8, wherein computing the action score for a training example of the plurality of training examples comprises:
identifying a set of actions described in the action logs that are associated with the interaction associated with the interaction data of the training example.

11. The method of claim 10, wherein computing the action score for a training example of the plurality of training examples comprises:
assigning a score to each action of the identified set of actions; and
computing an aggregated score based on the assigned scores.

12. The method of claim 8, wherein applying the action-based loss function to a constraint prediction, action score, and label comprises:
computing a weighted sum based on the constraint prediction and the action score.

13. The method of claim 8, wherein accessing the action logs comprises:
receiving action logs from another third-party system, wherein the action logs describe actions of users on that third-party system.

14. A method of claim 8, further comprising:
receiving interaction data from a third-party system describing an interaction of the user with the third-party system;
applying a constraint prediction model to the interaction data by accessing parameters for the constraint prediction model stored by the non-transitory computer-readable medium; and
predicting whether the interaction complies with a set of constraints based on the application of the constraint prediction model to the interaction data.

15. A non-transitory computer-readable medium storing instructions that, when executed by a processor, cause the processor to perform operations comprising:
initializing a set of parameters for the constraint prediction model;
accessing training data for the constraint prediction model, wherein the training data comprises a plurality of training examples, wherein each training example of the plurality of training examples comprises:
interaction data describing an interaction of a user with a third-party system; and
a label for the training example that indicates whether the interaction of the user with the third-party system complies with a set of constraints;
applying the constraint prediction model to the interaction data of each training example of the plurality of training examples to generate a set of constraint predictions for the plurality of training examples, wherein each constraint prediction indicates a predicted likelihood that the interaction of the corresponding training example complies with the set of constraints;
accessing action logs from an online system that describe actions taken by users of the online system to determine whether interactions of the plurality of training examples comply with the set of constraints;
computing an action score for each training example of the plurality of training examples based on the action logs, wherein each action score represents a number of actions taken by operators of the online system to determine whether the interaction of the corresponding training example complies with the set of constraints;
computing a loss score for each of the plurality of training examples by applying an action-based loss function to the constraint prediction, action score, and label for each of the plurality of training examples;
updating the set of parameters for the constraint prediction model through a backpropagation process using the computed loss scores for the plurality of training examples; and
storing a final set of parameters for the constraint prediction model to the computer-readable medium.

16. The computer-readable medium of claim 15, wherein the constraint prediction model comprises a neural network with a plurality of layers, wherein the plurality of layers comprises an input layer, a set of intermediate layers, and an output layer, wherein the input layer is connected to the set of intermediate layers, and the set of intermediate layers are connected to the output layer, and wherein applying the constraint prediction model to the interaction data of a training example comprises:
inputting, to the input layer, a feature vector associated with the interaction data of the training data;
receiving a constraint prediction from the output layer.

17. The computer-readable medium of claim 15, wherein computing the action score for a training example of the plurality of training examples comprises:
identifying a set of actions described in the action logs that are associated with the interaction associated with the interaction data of the training example.

18. The computer-readable medium of claim 17, wherein computing the action score for a training example of the plurality of training examples comprises:
assigning a score to each action of the identified set of actions; and
computing an aggregated score based on the assigned scores.

19. The computer-readable medium of claim 15, wherein applying the action-based loss function to a constraint prediction, action score, and label comprises:
computing a weighted sum based on the constraint prediction and the action score.

20. The computer-readable medium of claim 15, wherein accessing the action logs comprises:
receiving action logs from another third-party system, wherein the action logs describe actions of users on that third-party system.
